(19) United States
(12) Patent Application Publication
(10) Pub. No.: US 2002/0184966 A1
(43) Pub. Date: Dec. 12, 2002

(54) Damping structure for reducing chatter in a manifold

(76) Inventor: Jeff Powell, Belle River (CA)

Correspondence Address: LAURA M. SLENZAK, SIEMENS CORPORATION, 186 WOOD AVENUE SOUTH, ISELIN, NJ, 08830, US

(21) Appl. No.: 10/167,048

(22) Filed: Jun. 11, 2002

Related U.S. Application Data
(60) Provisional application No. 60/297,399, filed on Jun. 11, 2001.

(51) Int. Cl. G05G 1/00

(52) U.S. Cl. 74/574; 74/572

(57) ABSTRACT

A damping structure reduces chatter caused by shaft vibrations within a bearing bore in a manifold. The damping structure is incorporated into the shaft and has a resilient member and a contact member inside a shaft bore machined into the shaft. The contact member presses against the inside surface of the bearing bore, placing a load on the shaft that dampens chatter-inducing vibrations.

### REFERENCE TO RELATED APPLICATIONS

This application claims priority to U.S. Provisional Appln. No. 60/297,399, filed Jun. 11, 2001, the disclosure of which is incorporated by reference in its entirety.

### TECHNICAL FIELD

The present invention relates to active manifolds, and more particularly to structures that minimize or prevent noise in a manifold.

### BACKGROUND OF THE INVENTION

Some automobile intake manifold designs use one or more shafts having butterfly valves attached to the shaft to control air flow within the manifold. Each shaft is usually installed into a bearing bore within the manifold body or through bushings disposed in the bearing bore. Clearances between the shaft and the bearing bore, however, create undesirable chatter due to air flow and air pressure fluctuations within the manifold.

Although there have been proposed designs for reducing this chatter, current designs rely on incorporating damping structures into the manifold body. One proposed configuration places a spring-biased damping structure inside the manifold body so that it contacts the shaft and dampens shaft vibrations. Inserting a damping structure in the manifold body is often difficult, though, due in part to the configuration of the manifold body as well as the materials used to construct the manifold body.

There is a desire for an improved structure that can dampen vibrations causing system chatter within the manifold.

### SUMMARY OF THE INVENTION

Accordingly, the invention is directed to a damping structure that reduces chatter caused by shaft vibrations within a bearing bore in a manifold. A damping structure having a resilient member and a contact member is placed inside a shaft bore machined into the shaft. The contact member is disposed between the resilient member and an inside surface of the bearing bore. The resilient member places a load on the shaft to minimize chatter.

In one embodiment, the damping structure is held inside the shaft bore by a retainer. The retainer prevents the contact member and resilient member from falling out of the shaft bore.

### BRIEF DESCRIPTION OF THE DRAWINGS

FIG. 1 is a cross-sectional diagram of a shaft disposed in a bearing bore according to one embodiment of the invention;

FIG. 2 is a cross-sectional exploded diagram of a shaft structure according to one embodiment of the invention;

FIG. 3 is a cross-sectional exploded diagram of a shaft structure according to another embodiment of the invention;

FIG. 4 is a cross-sectional exploded diagram of a shaft structure according to a further embodiment of the invention.

### DETAILED DESCRIPTION OF THE EMBODIMENTS

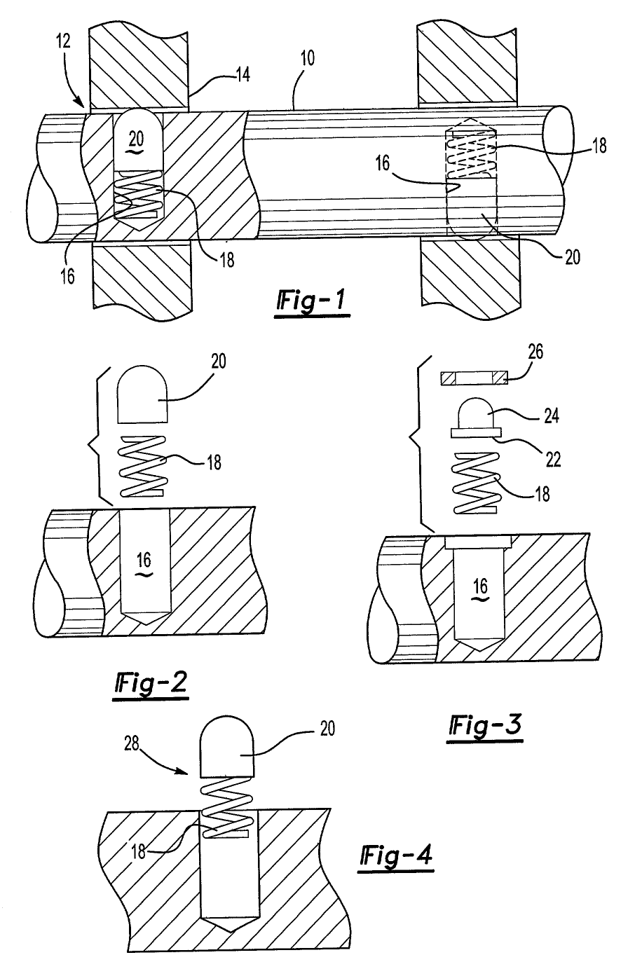

FIG. 1 generally illustrates one embodiment of the inventive damping structure. As noted above, an active manifold structure includes a shaft 10 disposed in a bearing bore 12 formed in a manifold body 14. Optional bushings (not shown) may also be disposed inside the bearing bore 12. The shaft 10 has one or more shaft bores 16 machined through the shaft's outer surface to a selected depth. In one embodiment, the shaft bore 16 extends only partially through the shaft 10 to ensure that any damping structure inserted into the shaft bore 16 will apply sufficient force to the shaft 10 to dampen vibrations. The shaft bore 16 can be formed anywhere on the shaft 10 as long as the shaft bore 16 opens to an inner surface of the bearing bore 12.

A resilient member 18 and a contact member 20 are disposed inside the shaft bore 16. The contact member 20 is preferably positioned to contact both the manifold body 14 and the resilient member 18, acting as an interface between the two. The resilient member 18 can be any resilient structure that can dampen shaft vibrations, such as a spring, a coil, a resilient plug, or any other similar structure. In one embodiment, the spring or coil is made from a metallic material. A polymer material may also be used to construct the resilient member 18, such as glass fiber-reinforced nylon or other similar material.

The contact member 20 may be made of any wear-resistant and/or self-lubricating properties, such as Teflon®, Delron®, Peek® or other similar materials. In one embodiment, the contact member 20 has a domed shape where the flat portion of the dome is attached to the resilient member 18 and the curved portion of the dome contacts the inner surface of the bearing bore 12. Other contact member 20 configurations (e.g., cylindrical) may also be selected.

Before the shaft 10 is placed inside the bearing bore 12, the resilient member 18 and contact member 20 are placed inside the shaft bore 16. The resilient member 18 may be compressed via retention pressure onto the contact member 20 so that the top of the contact member 20 does not interfere with the shaft's insertion into the bearing bore 12. When the shaft 10 is placed into the bearing bore 12 and any retention pressure on the contact member 20 is released, the resilient member 18 decompresses slightly so that the contact member 20 contacts the inside surface of the bearing bore 12 and exerts a load on the shaft 10. This load will dampen, and therefore minimize, any chatter caused by shaft movement within the bearing bore 12.

FIG. 3 illustrates an alternative embodiment of the inventive structure. This embodiment is designed to retain the resilient member 18 and contact member 20 within the shaft bore 16 during regular handling. In this embodiment, the contact member 20 has a retaining ledge 22 around its periphery, creating a nub 24. A retainer 26 fits over the nub 26 and holds the contact member 20 and the resilient member 18 inside the shaft bore 16 via an interference fit between the retainer 26 and the shaft bore 16. In one embodiment, the nub 24 portion of the contact member 20 moves freely inside the retainer 20 to absorb and dampen any shaft vibrations within the bearing bore 12. This embodiment simplifies assembly of the shaft 10 into the manifold body 14 because the retainer 26 prevents the contact member 20 and resilient member 18 from falling out of the shaft bore 16 during manufacturing.

FIG. 4 illustrates yet another embodiment of the inventive structure. In this embodiment, the resilient member 18 and contact member 20 are integrated together to form a unitary damping structure 28. In one possible structure, the resilient member 18 and contact member 20 are manufactured as one piece to form the damping structure 28. The damping structure 28 may be manufactured from any material that has resilient properties for dampening chatter and wear properties for withstanding prolonged contact with the inside surface of the bearing bore 12, including but not limited to Teflon®, Delron®, and Peek®. The damping structure shown in FIG. 4 may also be designed to accommodate the retainer 20 shown in FIG. 3.

As a result, the invention incorporates a damping structure into the shaft rather than into the manifold body, making it easier to manufacture a manifold with minimal chatter. The outside surface of the shaft is more easily accessible than the inside surface of the bearing bore, making the inventive structure amenable to variations in the damping structure.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A damped shaft to be inserted into a bearing bore having an inner surface, comprising:
a shaft bore formed in the shaft;
a resilient member disposed inside the shaft bore; and
a contact member coupled to the resilient member, wherein the contact member contacts the inner surface of the bearing bore and exerts a load onto the shaft.

2. The damped shaft of claim 1, wherein the resilient member is selected from the group consisting of a spring, a coil, and a resilient plug.

3. The damped shaft of claim 1, wherein the resilient member is made from one selected from the group of a metallic material and a polymer.

4. The damped shaft of claim 1, wherein the contact member is made of at least one selected from the group consisting of Teflon®, Delron®, and Peek®.

5. The manifold of claim 1, wherein the contact member has a domed portion and a flat portion, wherein the flat portion contacts the resilient member and the domed portion contacts the inner surface of the bearing bore.

6. The damped shaft of claim 1, further comprising a retainer that holds the contact member and the resilient member inside the shaft bore.

7. The damped shaft of claim 6, wherein the retainer is annular, and wherein the contact member has a retaining ledge and a nub that is extendible through the retainer.

8. The damped shaft of claim 1, wherein the contact member and the resilient member are integrated together into a unitary structure.

9. The damped shaft of claim 8, wherein the contact member and the resilient member are of the same material.

10. A manifold having a damped shaft inserted into a bearing bore in the manifold, the bearing bore having an inner surface, comprising:
a shaft bore formed in the shaft, wherein the shaft bore opens to the inner surface of the bearing bore;
a resilient member disposed inside the shaft bore; and
a contact member in contact with the resilient member, wherein the contact member contacts the inner surface of the bearing bore and exerts a load onto the shaft.

11. The manifold of claim 10, further comprising a retainer that that holds the contact member and the resilient member inside the shaft bore.

12. The manifold of claim 11, wherein the retainer is annular, and wherein the contact member has a retaining ledge and a nub that is extendible through the retainer.

13. The manifold of claim 10, wherein the contact member and the resilient member are integrated together into a unitary structure.
